(19) United States
(12) Patent Application Publication
(10) Pub. No.: US 2006/0075395 A1
(43) Pub. Date: Apr. 6, 2006

(54) Flash card system

(76) Inventors: Charles C. Lee, Sunnyvale, CA (US); Ikang Yu, Palo Alto, CA (US)

Correspondence Address: SAWYER LAW GROUP LLP, P.O. Box 51418, Palo Alto, CA, 94303, US

(21) Appl. No.: 10/957,089

(22) Filed: Oct. 1, 2004

(51) Int. Cl. G06F 9/24; G06F 9/44; G06F 12/00

(52) U.S. Cl. 717/168; 711/103; 713/2

(57) ABSTRACT

A flash memory system is disclosed. The flash memory system includes a flash controller and at least one flash memory device coupled to the flash controller. The boot code and control code for the flash memory system are stored in the flash memory device. Because the boot code and the control code are stored in the flash memory device instead of in a ROM, the boot code and control code can be updated in the field. Also, the flash controller can support multiple brands and types of flash memory in the flash memory system to eliminate stocking issues.

### FIELD OF THE INVENTION

The present invention relates to memory systems, and more particularly to an adaptable flash card system.

### BACKGROUND OF THE INVENTION

Multimedia cards (MMC) that use flash memory are popular for storing data. Flash memory-based MMCs (or “flash cards”) are well known and are used in products such as digital cameras. Benefits of flash cards include low-power dissipation and high resistance to vibration. These are primary reasons why flash cards have been replacing magnetic materials such as floppy disks.

FIG. 1 is a block diagram of a conventional flash card 50 coupled with a user host 52. The flash card 50 includes a flash controller 60 and a flash memory device 62. The user host 52 can be a camera or a PC, for example. Data is transferred between the user host 52 and the flash memory device 62 via the flash controller 60. Information required for accessing the flash device 62 is stored in a read-only memory (ROM) 64 in the flash controller 60. Such information includes boot code 66 and control code 68. The boot code 66 is software that initializes the flash card 50 during the early phase of the booting sequence. The control code 68 contains both necessary information to exercise the initial booting sequence, and information that enables the flash controller 60 to access the flash memory device 62.

A problem with conventional flash memory systems is that is the boot code 66 and/or the control code 68 can have bugs, which may not be discovered until the flash memory system is already in the field. Also, the boot code 66 and/or the control code 68 may have to be updated due to bugs or due to improvements to the codes.

The conventional solution is to replace the flash controller 60 as it contains the ROM 64, in which the boot code 66 and the control code 68 are stored. A problem with this solution is that it can cause significant inventory issues for a flash card manufacturer. For instance, an entire stock of flash controllers may have to be thrown out for one fix or for an update to the boot code or to the control code. Hence, a new stock of flash controllers would have to be ordered. This can be an on-going problem if subsequent updates are required.

Accordingly, what is needed is an improved flash memory system. The system should be adaptable, simple, cost effective, and capable of being easily adapted to existing technology. The present invention addresses such a need.

### SUMMARY OF THE INVENTION

A flash memory system is disclosed. The flash memory system includes a flash controller and at least one flash memory device coupled to the flash controller. Boot code and control code for the flash memory system are stored in the flash memory device. Because the boot code and the control code are stored in the flash memory device, the boot code and control code can be updated in the field.

### BRIEF DESCRIPTION OF THE DRAWINGS

FIG. 1 is a block diagram of a conventional flash card coupled with a user host.

FIG. 2 is a block diagram of a flash memory system in accordance with the present invention.

FIG. 3 is a block diagram of the flash controller of FIG. 2 in accordance with the present invention.

FIG. 4 is a diagram of a flash memory structure in accordance with the present invention.

FIG. 5 is a block diagram of a flash memory system, including two flash memory devices using a dual channel configuration, in accordance with the present invention.

FIG. 6 is a diagram of flash memory structures for the flash memory devices of FIG. 5 in accordance with the present invention.

FIG. 7 is a timing diagram for the flash memory system of FIG. 5 in accordance with the present invention.

FIG. 8 is a block diagram of a flash memory system including two interleaved flash memory devices in accordance with the present invention.

FIG. 9 is a diagram of flash memory structures for the flash memory devices of FIG. 8 in accordance with the present invention.

FIG. 10 is a diagram of flash memory structures for the flash memory devices of FIG. 8 in accordance with another embodiment of the present invention.

FIG. 11 is a timing diagram for the flash memory system of FIG. 8 in accordance with the present invention.

FIG. 12 is a chart showing an organization of data in accordance with the present invention.

FIG. 13 is a timing diagram for a flash memory system in accordance with the present invention.

FIG. 14 is a flow chart showing a method for programming a flash card using a manufacturer host in accordance with the present invention.

FIG. 15 is a flow chart showing a method for programming a flash card using a flash programmer in accordance with the present invention.

FIG. 16 is a flow chart showing a method for booting a flash card in accordance with the present invention.

FIG. 17 is a flow chart showing a method for testing a flash card before shipping in accordance with the present invention.

FIG. 18 is a block diagram of memory structures in accordance with the present invention.

FIG. 19 is a flow chart showing a method for powering up a flash card during normal operation in accordance with the present invention.

FIG. 20 is a flow chart showing a method for implementing control code during normal operation in accordance with the present invention.

FIG. 21 is a side-view diagram of a conventional multimedia card (MMC).

FIG. 22 is a side-view diagram of an MMC in accordance with the present invention.

FIG. 23 is a side-view diagram of a conventional MMC.

FIGS. 24A, 24B, and 24C are top-view, back-view, and side-view diagrams, respectively, of a conventional MMC.

FIGS. 25A, 25B, and 25C are top-view, back-view, and side-view diagrams, respectively, of an MMC in accordance with the present invention.

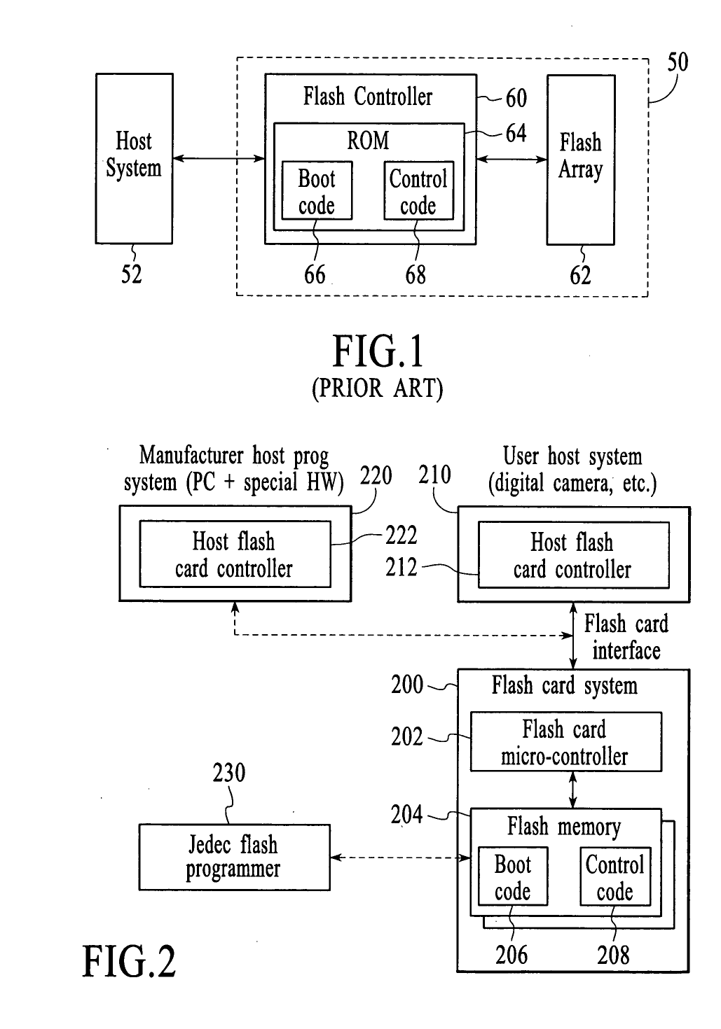

### DETAILED DESCRIPTION OF THE INVENTION

The present invention relates to memory systems, and more particularly to an adaptable flash card system. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

A system in accordance with the present invention for providing a flash memory system is disclosed. The boot code and the control code are stored in the flash memory instead of in the flash controller. As a result, the boot and control codes can be updated in the field without having to change the flash controller. To more particularly describe the features of the present invention, refer now to the following description in conjunction with the accompanying figures.

Although the present invention disclosed herein is described in the context of a flash card, the present invention may apply to other types of memory systems and still remain within the spirit and scope of the present invention.

FIG. 2 is a block diagram of a flash memory system 200 in accordance with the present invention. The flash memory system 200 includes a flash controller 202 and a flash memory 204. The flash memory 204 stores boot code 206 and control code 208. Note that the term flash memory represents one or more flash memory devices. If there are more than one flash memory device, the boot code 206 and control code 208 can be stored on one of the flash memory devices or alternatively can be stored on multiple flash memory devices. The flash memory system 200 is adapted to be coupled to a user host 210 during normal-mode operation. The user host 210 includes a host flash controller 212.

During programming-mode, the flash memory system 200 is adapted to be coupled to a manufacturer host 220 or alternatively to a Jedec flash programmer 230. The manufacturer host 220 can be a personal computer (PC) with special hardware. The manufacturer host 220 includes a host flash controller 222, which can be a special card interface controller dedicated to volume production of flash cards.

In normal-mode operation, the flash memory system 200 stores data that is provided by the user host 210, which may be a digital camera or PC. The flash memory system 200 is implemented as a flash card. The flash memory system 200 can store various types of data including image data and other types of multimedia data. Accordingly, the flash memory system 200 can also be referred to as a multimedia card (MMC). The data stored in the flash memory system 200 can be later sent as file attachment in an e-mail, printed, or transferred to another host.

The host card controller 212 handles flash card protocol translation between the flash memory system 200 and the user host 210, which enables the user host 210 to transfer files so that various host operating system (OS) software can share information. For example, the host card controller 212 enables data to be read by a user PC via email. Software in the user host 210 handles file system functions, such as providing a file application interface and providing a user accessible device driver.

Before the flash memory system 200 is shipped to an end user, information is stored in the flash memory system 200 to ensure that it functions correctly. The information includes the boot code 206 and the control code 208, as well as information specific to the flash memory (e.g., manufacturer, identification, etc.). The boot code 206 is software that initializes the flash memory system 200 during the early phase of the booting sequence. The boot code 206 also determines the amount of available memory and determines how to access it. The control code 208 contains necessary information for exercising the initial booting sequence and information for enabling the flash controller 202 to access the flash memory device 204. The control code 208 includes parameter settings and a detailed list of information relating to flash memory, as well as card identification (card ID) and card specific data (CSD).

Because the boot code 206 and the control code 208 are stored in the flash memory instead of the ROM, the code in the ROM as well as the physical size of the ROM can be minimized.

In programming-mode operation, the manufacturer host 220 is used to program the flash memory 204 via the flash controller. Alternatively, the Jedec programmer 230 can be used to directly program the flash memory 204. Upon completion of the programming, the manufacturer host 220 diagnoses the flash memory system 200 to ensure that it is functioning properly.

Because the boot code and control code is stored in the flash memory 200, different brands or types of flash memory can be supported by the same flash controller 202 without having to change it. As such, the flash controller is universal to various brands and types of flash memory. This is because each flash memory device of the flash memory 204 stores the boot and control code unique to each flash memory. Parameters for different types of flash memory device parameters are defined in the control code and in a library image file. Accordingly, a single flash controller can support multiple brands and multiple types of flash memory. In other words, the flash controller would not have to be changed for each brand or type of flash memory. This significantly reduces the inventory when cards having various specifications (i.e., different flash memories) are in mass production.

Furthermore, because the boot code and the control code are stored in the flash memory, the boot and control codes can be updated in the field. As such, the end user can download updated code. Such code can be provided via various means including Internet web support, e-mail, etc., and can be downloaded using a PC.

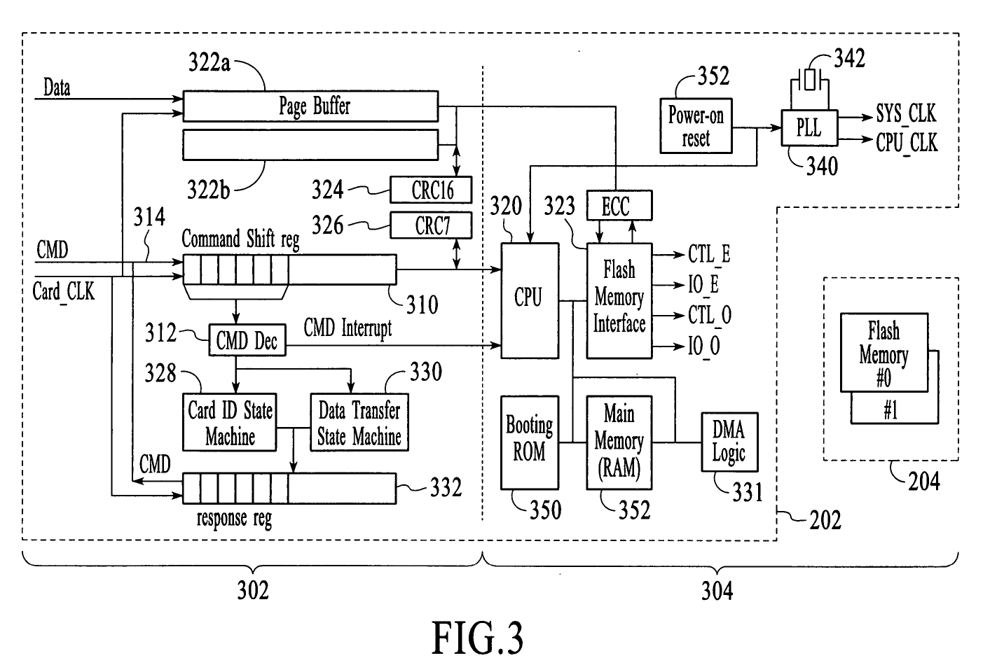

FIG. 3 is a block diagram of the flash controller 202 of FIG. 2 in accordance with the present invention. For ease of illustration, the flash controller 202 of FIG. 3 is shown in two clock domains, a card clock domain 302 and a central processing unit (CPU) clock domain 304. The card clock domain 302 is controlled by a card clock (labeled “card_clk”), which is provided by a host (not shown) to synchronize the command and data protocols. Note that the term host, when used generally, can include any type of host including but not limited to a user host, a manufacturer host, Jedec programmer, etc. All handshake signals follow the card clock to execute transactions.

The CPU clock domain 302 is controlled by a CPU clock (labeled “CPU_clk”). The CPU clock controls all flash operations as well as CPU activity. The speed of the CPU clock can be high for efficient execution (e.g., two times or more faster than the card clock). The speeds of the clocks can and will increase as technology advances, and their precise speeds will depend on the specific application.

Referring to the card clock domain, a command shifter register 310 is used to latch a command via a command line 314 from a host whenever the shift register 310 sees a start bit sending from the host. As stated previously, the term host when used generally can include any type of host including but not limited to a user host, a manufacturer host, etc. The command line 314 is bi-directional. Accordingly, responses from the flash memory system to the host can use the command line for protocol transfers.

A command decoder 312 generates a command interrupt, which is sent to a CPU 320. Double page buffers, 322a and 322b, are used to increase the performance of flash operations. In this specific embodiment, the page buffers 322a and 322b are 2 K bytes, but can be more or less depending on the specific application. The flash controller 202 alternates between the page buffers 322a and 322b to optimize traffic between the host and the flash controller 202. While the page buffer 322a is in use sending data to a flash memory interface 323, the page buffer 322b remains available to receive data from the host. Conversely, while the page buffer 322b is in use sending data to the host, the page buffer 322a remains available receive data from the flash memory.

A cyclic redundancy check unit 324 (labeled “CRC16”) checks checksums for larger bytes of data (e.g., 512 or more bytes). A cyclic redundancy check unit 326 (labeled “CRC7”) checks checksums for smaller bytes of data. Such data includes, for example, command or response packet checks. A card identification (ID) state machine 328 ensures that the flash controller 202 is recognized by the host. Each state involves complex operations handled by the firmware of the CPU 320. A data transfer state machine 330 facilitates a direct memory access/addressing (DMA) engine logic 331 to alleviate the CPU 320 when downloading boot or control code. The DMA transfers large blocks of code from the flash memory to the main memory. This speeds up execution running in RAM-based memory, as well as relieves the CPU. A response register 332 facilitates data transfer from the flash memory system to the host.

Referring to the CPU clock domain 304, the CPU 320 is the main engine for control sequencing and is also responsible for handling firmware sequencing. A phase locked loop (PLL) circuit 340 with a crystal 342 generates the CPU clock and a system clock (labeled “sys_clk”), which are primarily used for the CPU 320 and the flash memory interface 322. The clock speeds affect flash timing. A preferred speed is 20 Mhz state tracking, and may vary depending on the specific application.

A read-only memory (ROM) 350 stores code that handles the downloading of code to the flash memory device 204 and transfers control to the boot code residing in the flash memory 204. Alternatively, the ROM 350 can be replaced by a fixed-type electronically erasable ROM (EEPROM) or a NOR type flash memory. Such alternatives would be useful for engineering experiment purposes.

A main memory static random access memory (SRAM) 352 stores executable code, including the boot code and the control code, which are downloaded from the flash memory 204 when the flash memory system boots up. Depending on complexity of the control code, the RAM 352 can be integrated with the CPU 320. A rich-RAM based 8051 controller is example of a RAM integrated with a CPU.

The flash memory interface circuit 322 interfaces with the flash memory during flash memory access operations, to fulfill the task of programming/reading/erasing flash pages or blocks based on commands sent from the host.

The flash card uses a block-based addressing scheme, as opposed to a random addressing scheme, which is common with dynamic random access memory (DRAM) systems. Block-based addressing involves a command and an address, which are sent over a data bus and involves a block of data, which is read or written. A benefit of flash memory is that the data bus is used to send both commands and addresses, in addition to sending user data. As a result, fewer pins are needed on a flash memory chip. Hence, costs are reduced.

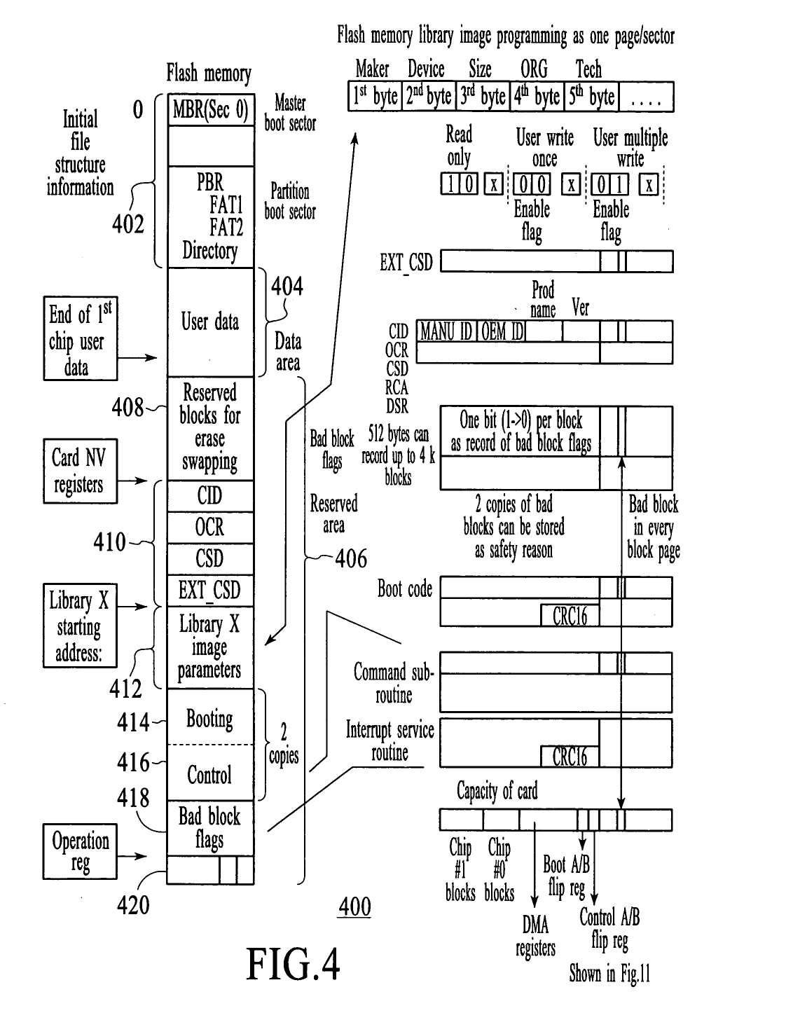

FIG. 4 is a diagram of a flash memory structure 400 in accordance with the present invention. A reserved area 406 in the last blocks of the flash memory are used for storing information associated with the flash memory operations (e.g., the boot code and the control code). Such information includes reserved blocks 408, card non-volatile (NV) registers 410, a library image file 412, boot code 414, control code 416, a bad block map 418, and operation registers 420.

The reserved area includes at least two blocks, which includes a spare block used for temporary copies of old final block data. The reserved blocks 408 are used for erase swapping. After old final block data is erased, new data is copied back. Wear leveling problems are not at issue in the reserved area, since updates to either codes or registers occur very infrequently compared to normal data transfers.

The card non-volatile (NV) registers 410 contain necessary parameters, such as card identification (CID) data that the host needs to know to transfer protocols. The library image file 412 includes a maker byte, a device byte, and other information read from a flash command.

With regard to the boot code 414 and the control code 416, at least two copies of each are stored in the flash memory device. This provides a back-up copy during updates. During an update, only one of the two copies is updated to reflect the latest changes. The other copy is saved as a backup copy without any changes, in case any unknown failures occur during the update. Also, two sections are toggled such that during a subsequent update, the original backup copy is updated with the latest code, and the copy of the first update becomes the new backup copy. While two copies are stored in this specific embodiment, more copies can exist if the memory size is sufficient. Additional blocks can be reserved to accommodate larger sizes of boot and control code.

The bad block map 418 records the bad blocks. Bad blocks in the flash memory may manifest at various times, including when the block was first created, and can occur in later stages while being erased or programmed. In a specific embodiment, each block is represented by one bit, where a logical one (“1”) represents a good block and a logical zero (“0”) represents a bad block. The bad block mapping table also indicates the remaining life of the flash memory based on the ratio of good blocks to bad blocks. All flash memory brands have specification-defined positions for bad blocks, which is known after reading the maker code. Such positions are typically located several bytes after the beginning position of a spare data area. The reserved area 406 would not include any bad blocks detected during a block scan.

The operation registers 420 contain checksum data and address pointers. The address pointers are shared with DMA flash address starting registers. Also stored in this sector is basic information that the card controller requires, such as pointers to the copies of the boot code and the control code, the start address, and the user storage capacity of the flash memory system.

The user storage capacity of the flash memory device is calculated from a flash chip specification volume, which is known after reading organization bytes after a “90 command” ID is read. The user storage capacity is the flash chip specification volume minus the reserved blocks minus the bad blocks.

The flash memory system can have one or more flash memory devices. The specific number of flash memory devices will depend on the requirements of the specific application. If more than one flash memory device is used, the flash memory devices are preferably the same make and type. However, they need not be the same make or typed.

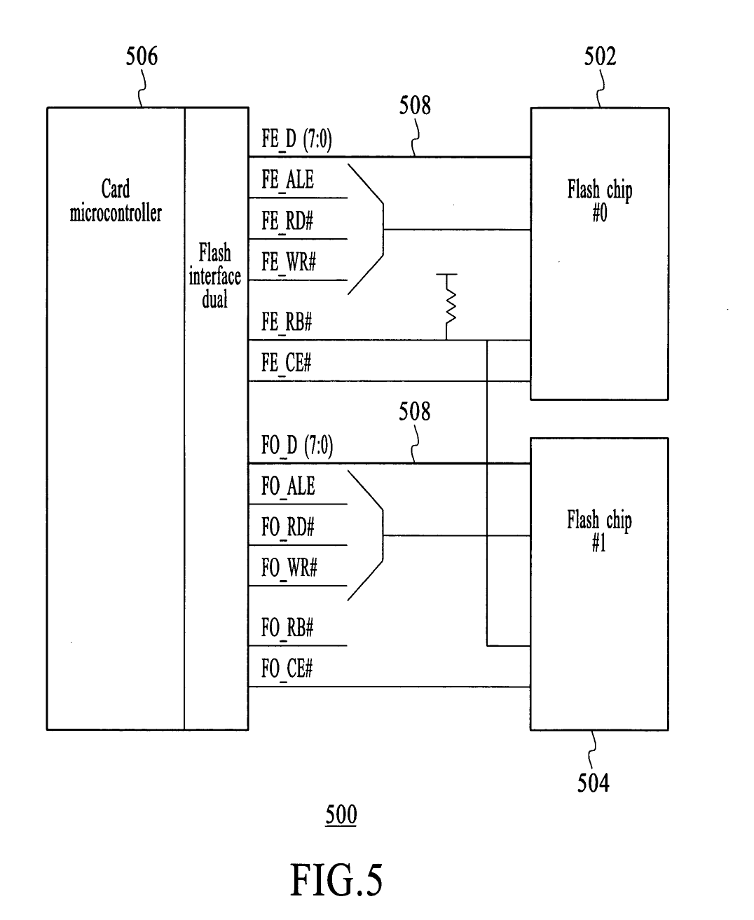

FIG. 5 is a block diagram of a flash memory system 500 having two flash memory devices 502 and 504 using a dual channel configuration in accordance with the present invention. The flash memory devices 502 and 504 are coupled to a flash controller 506 via an input/output (I/O) bus 508. The I/O bus 508 is double the width of a bus that would be used for only one flash memory device. Accordingly, the performance of the I/O bus 508 is twice as fast as a bus using single line control logic.

The flash memory devices 502 and 504 are 8-bit devices and the address space of the flash memory devices 502 and 504 are rearranged by interface logic to enable access to them. Their sector sizes are 512 bytes. The ready/busy# line (labeled “FE_RB#”) indicates an internal busy status.

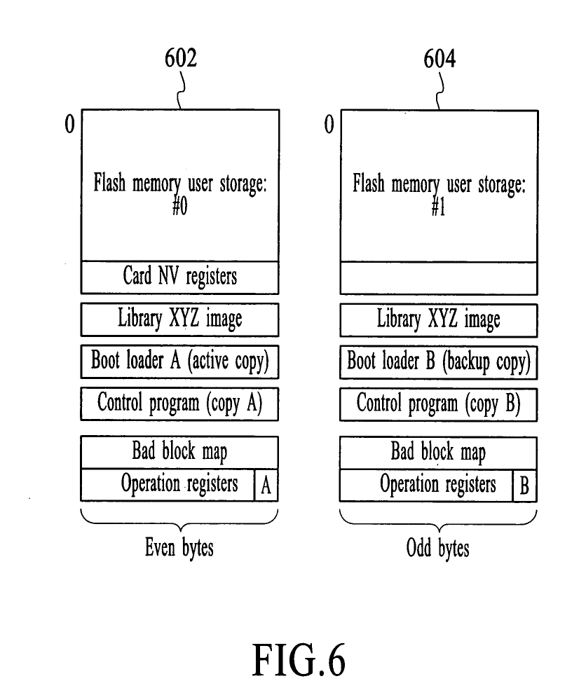

FIG. 6 is a diagram of flash memory structures 602 and 604 for the flash memory devices 502 and 504, respectively, of FIG. 5 in accordance with the present invention. The flash memory structures 602 and 604 are similar to the flash memory structure of FIG. 4, except that the physical addresses of flash memory are separated into two flash memory devices. The flash memory structure 602 is designated for even bytes, and the flash memory structure 604 is designated for odd bytes.

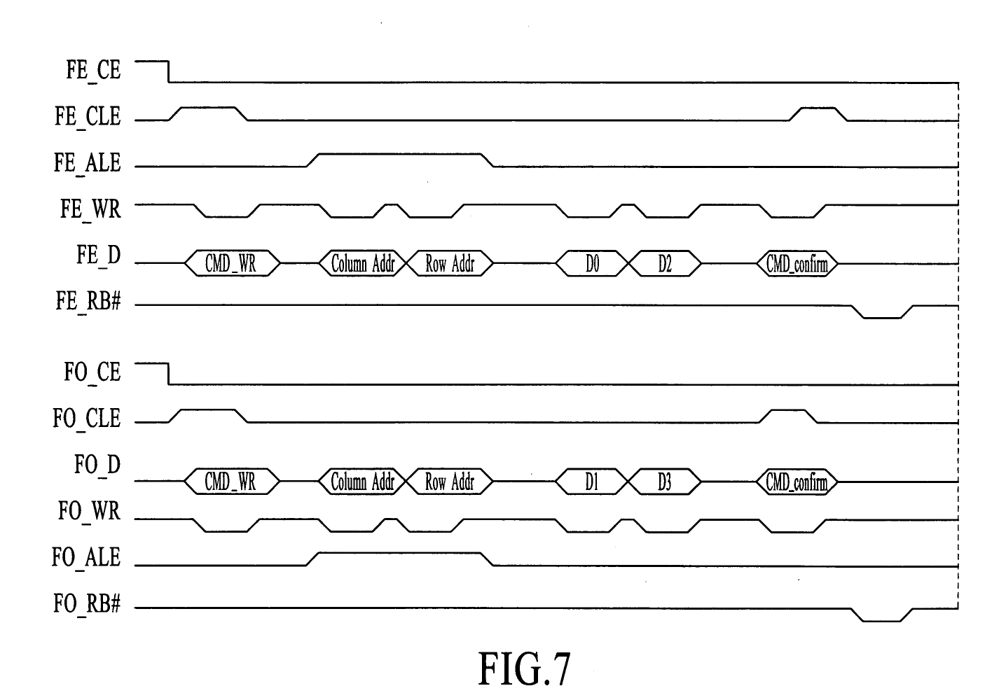

FIG. 7 is a data write timing diagram for the flash memory system 500 of FIG. 5 in accordance with the present invention. First, during a command phase (labeled “CMD_WR”), a command is written to the flash memory devices 502 and 504 in accordance with their flash memory specifications. Next, during an address phase (labeled “Column Addr” and “Row Addr”), the column and row addresses are accessed in two separate consecutive cycles. The specific number of cycles will depend on the specific application. Next, during a data phase (labeled “D0“−”D3”), data sent accessed to the flash memory devices 502 and 504. This is done in a staggered format to gain performance. Two sector buffers, each having 512 bytes, are used for odd and even bytes sent to the flash memory devices 502 and 504. In a final phase (labeled “CMD_Confirm”), error correction code (ECC) bytes associated with odd bytes are written in spare locations of each sector. With regard to the last signal (FO_RB#), the waveform represents the Ready/Busy pin output for flash memory device 504. The FO_RB# pin is un-connected. Because the RB# pins for the flash memory devices 502 and 504 are tri-stated, they can alternatively be tied together.

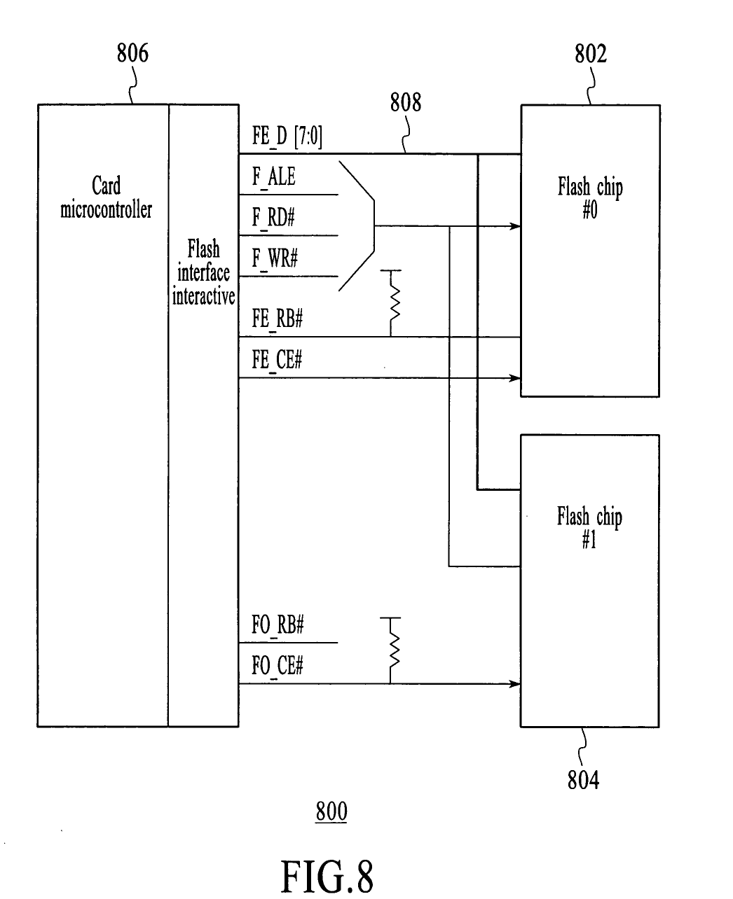

FIG. 8 is a block diagram of a flash memory system 800 including two interleaved flash memory devices 802 and 804 in accordance with the present invention. The flash memory devices 802 and 804 are coupled to a flash controller 806 via an I/O bus 808. The flash memory devices 802 and 804 timeshare the I/O bus 808. Accordingly, commands can be sent to both flash memory devices 802 and 804 to fully utilize the bandwidth of the I/O bus 808. Because the I/O bus 808 is shared, the flash controller 806 pin count is reduced. While the flash memory devices 802 and 804 share the I/O bus 808, they each have separate chip enable lines (labeled “FE_CE#” and “FO_CE#”) and ready/busy lines (labeled “FE_RB#” and “FO_RB#”).

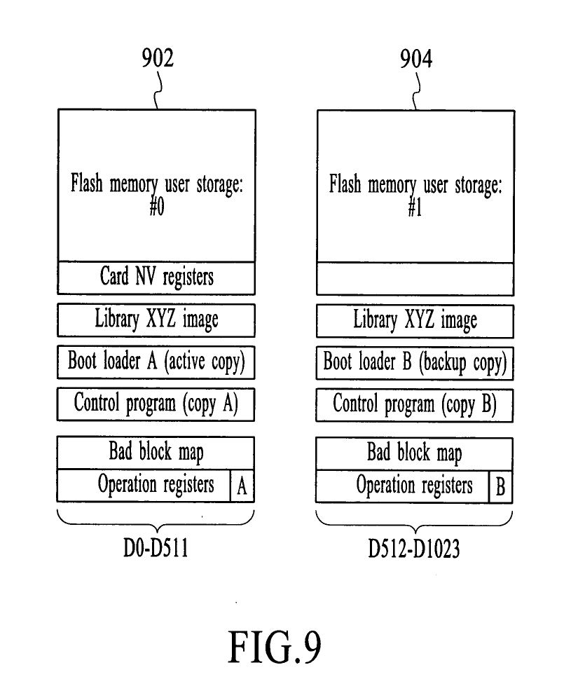

FIG. 9 is a diagram of flash memory structures 902 and 904 for the flash memory devices 802 and 804, respectively, of FIG. 8 in accordance with the present invention. The flash memory structures 902 and 904 are similar to the flash memory structures 602 and 604 of FIG. 6. All data from the registers, the library image file, and the boot and control codes are aligned sequentially and separated into the two flash memory structures 902 and 904. As shown, the flash memory structure 902 is designated for a first series of bytes (labeled “D0-D511”), and the flash memory structure 904 is designated for a first series of bytes (labeled “D512-D1023”).

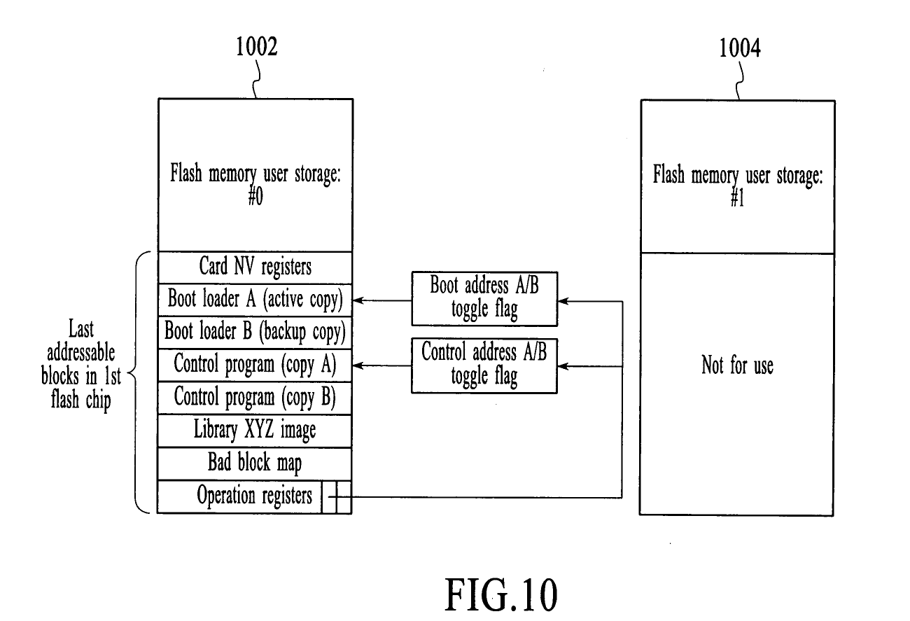

FIG. 10 is a diagram of flash memory structures 1002 and 1004 for the flash memory devices 802 and 804, respectively, of FIG. 8 in accordance with another embodiment of the present invention. The flash memory structures 1002 and 1004 differ from the flash memory structures 902 and 904 of FIG. 9 because the registers, boot code, and control code, library image file, bad block map, and operation registers are stored on one flash memory device. The interleave feature can be turned on after the control code is successfully downloaded. The interleave feature is turned off every time the bad block map or other bits are changed. This is also the case with the dual channel feature described above.

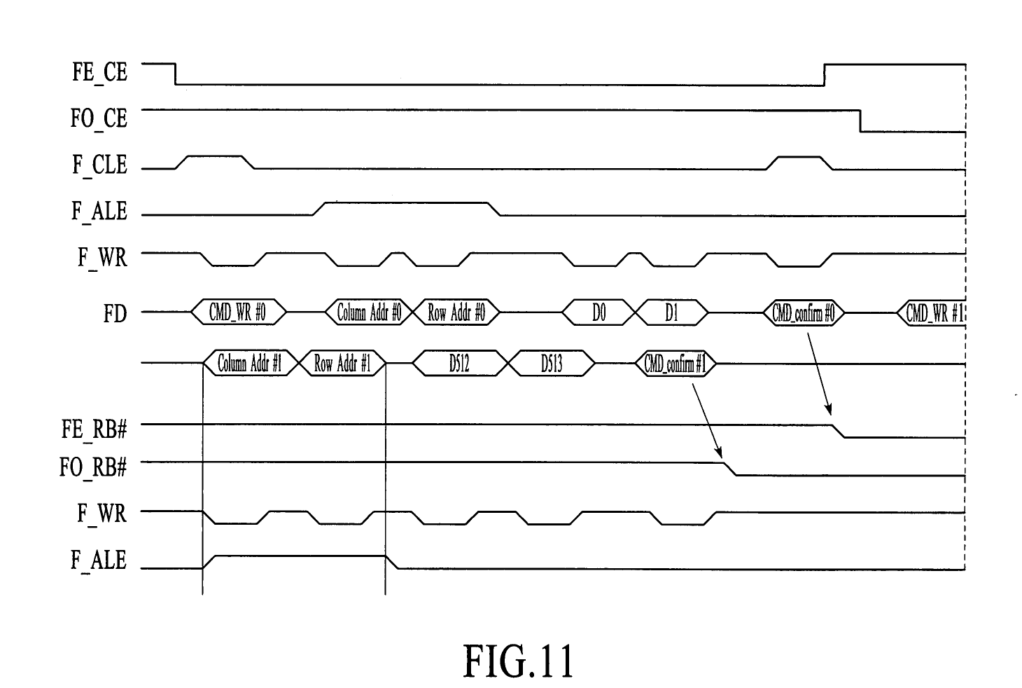

FIG. 11 is a timing diagram for the flash memory system of FIG. 8 in accordance with the present invention. Access to the flash memory devices begins with the first flash memory device and continues with the second flash memory device. Because the I/O bus is timeshared between the first and second memory devices, access alternates between the two. The sequence is similar to that of the timing diagram of FIG. 7. With both flash memory devices, after a confirm-command is issued, a CE# is released and an RB# is asserted for internal busy status.

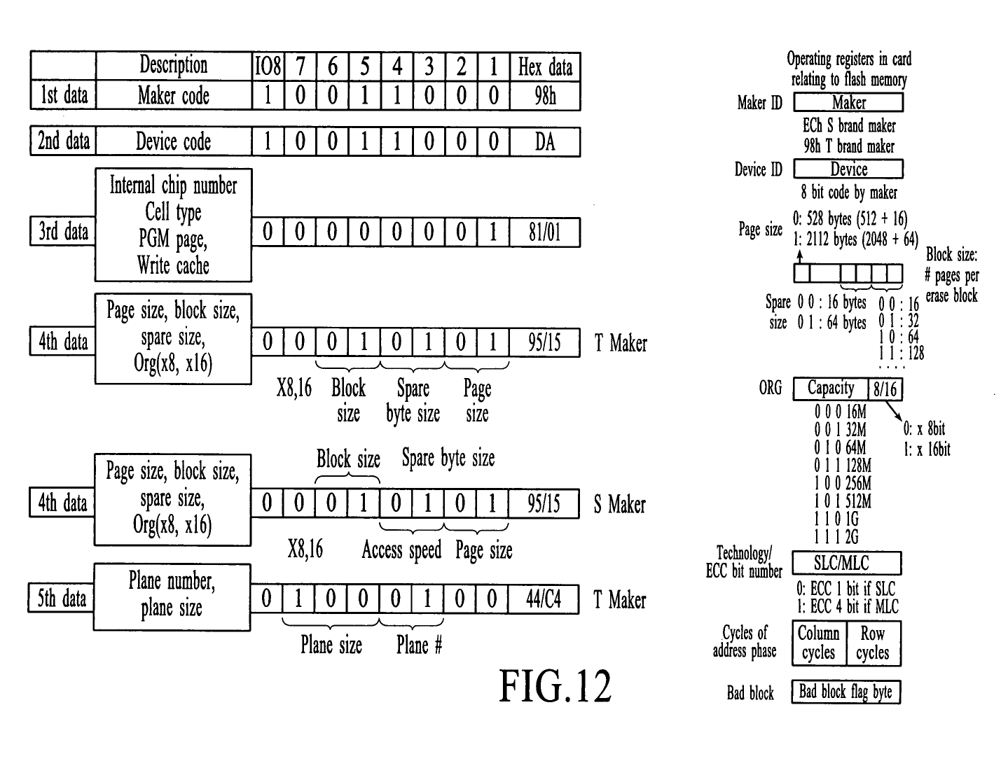

FIG. 12 is a chart showing an organization of data in accordance with the present invention. Information critical to the operation of a flash memory device is provided by the manufacture. The control code provides this information to the flash controller. Each brand and type of flash memory device has its own addressing scheme and capacities. The operating register in the flash memory device provides this information, which can be grouped together into one page for easy access by the flash controller. The data organization of two major brands of flash memory, Maker T and Maker S, are shown. The first set of data includes the maker code. The second set of data includes the device ID. All brands and types of flash memory have an associated device ID. A special command (“code 90”) is issued after a second address phase. This is the only necessary control for reading flash the device ID. The third set of data includes the internal chip number and cell type.

The fourth set of data returned has different meanings for different flash devices. For example, an error correction code (ECC) generation circuit will be a 1-bit circuit if using a single level cell (SLC) cell structure or will be a 4-bit circuit if using multi-level cell (MLC) cell structure. The operating registers also include an address cycle register, which facilitates read/write access. Other necessary information includes block size, page size, and spare size.

If more that one flash memory device is used, the ROM need only read the first flash memory device to gather needed information. If multiple brands or types of flash memory devices are used, the ROM would read each device. If more than one flash memory device is used, the same brand and type is preferred in order to minimize the control code.

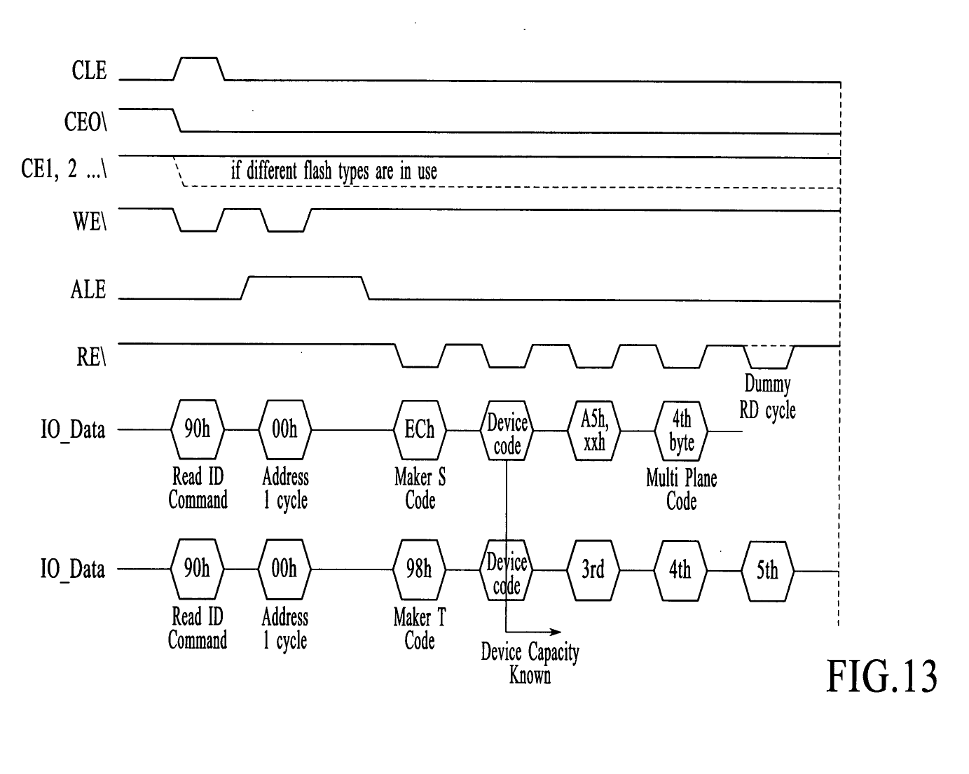

FIG. 13 is a timing diagram for a flash memory system in accordance with the present invention. In a first phase, a read ID command is issued. In a second phase, an address is determined. In a third phase, the maker code is read. In a fourth phase, the device code is read. In a fifth phase, other types of data are read. This data includes page size, block size, spare size, etc.

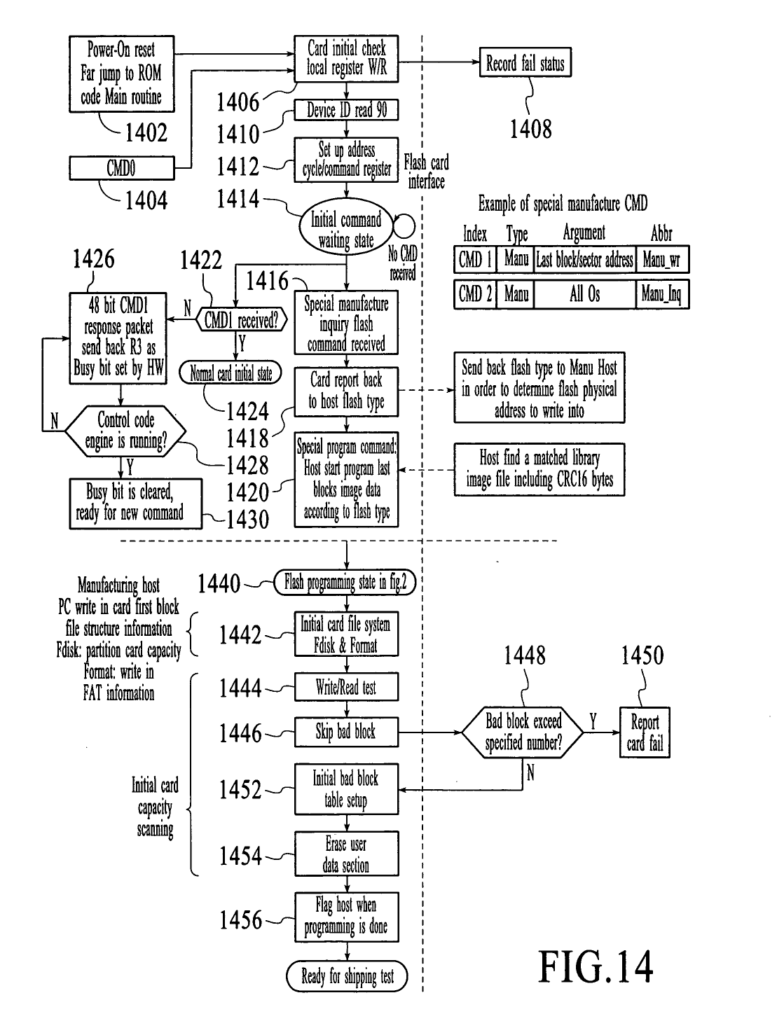

FIG. 14 is a flow chart showing a method for programming a flash card using a manufacturer host in accordance with the present invention. An interrupt service routine is executed when a power-on reset is detected in the flash memory system, in a step 1402. The power-on reset is detected when the flash memory system is connected to the manufacturer host or when host power is turned on after a flash memory system has been connected to a host system. A voltage sensor in the flash memory system checks the incoming voltage as it increases to an operating voltage. A global reset synchronizes all state machines in the flash memory system and initializes all local registers to default values. The reset signal is removed when the PLL is stabilized.

A first command (“CMD0”) from the manufacturer host is issued, in a step 1404. The first command initializes all of the state machines in the flash memory system.

Next, local registers are checked to ensure that they function properly, in a state 1406. If the local registers fail the check, they are rejected and failures are recorded, in a step 1408. Next, the flash memory device ID is read, in a step 1410. ROM code instructs the CPU to send the flash commands to a flash interface circuit for this purpose. Next, local control registers will be loaded for correct operation, in a step 1412. This is performed while reading parameters of the flash memory device. The parameters include address phase cycles and sizing registers, which are different for different types of flash memory devices.

After completion of steps 1410 and 1412, the flash memory system goes into a command waiting state, remaining responsive to further instructions, in a step 1414. Such instructions can include a special manufacturer host inquiry or a command. The manufacturer host uses a special command to initiate the programming. If a special manufacturer inquiry is received, in a step 1416, the flash memory system provides the type of flash memory device to the manufacturer host, in a step 1418. The type is typically provided in 4 bytes. The manufacturer host uses this information to determine the physical address of system data for the flash memory device, and writes this information to a library image file. Next, a manufacturer host sends the information file to the flash memory system, in a step 1420. The information is associated with the specific type of flash memory device and includes a library image file, card non-volatile registers, bad block maps, and operation registers. The operation registers include boot and control code starting addresses, flip pointers, and the capacity of the flash memory.

If a normal command (“CMD1”) is received, in a step 1422, the flash card goes into a normal operating mode, in a step 1424. If not, a pre-hardcode VDD voltage profile is sent back, in a step 1426. The last bit, which is a busy bit, is set. The last bit indicates that the flash memory system is either “busy” (set) or is “not ready” (cleared). Next, it is determined whether the control code engine is running, in a step 1428. Next, the busy bit is cleared, in a step 1430, unless the control code engine is running.

After the step 1420, the flash card goes into programming mode, in a step 1440. The following steps are directed to programming the flash memory device. First, a primary partition is created, and the flash memory device is formatted with file structure information, in a step 1442. The file structure information can include a master block record (MBR), a partition block record (PBR), and an initial root directory and FAT16 information. The specific file structure information required will depend on the type of operation system of the host (e.g., PC, Linux or Mac OS).

Next, a write/read test is performed, in a step 1444. During this test, bad blocks are identified and handled accordingly, in a step 1446. Next, it is determined whether the number of bad blocks exceeds a specified number, in a step 1448. If so, a failure report is generated, in a step 1450. If not, a bad block map is established, in a step 1452. Bad blocks are recorded in the bad block map. Next, the user data section is erased, in a step 1454. The sections storing system data and non-volatile registers are not erased. Next, the manufacturer hose is flagged when the programming is completed, in a step 1456.

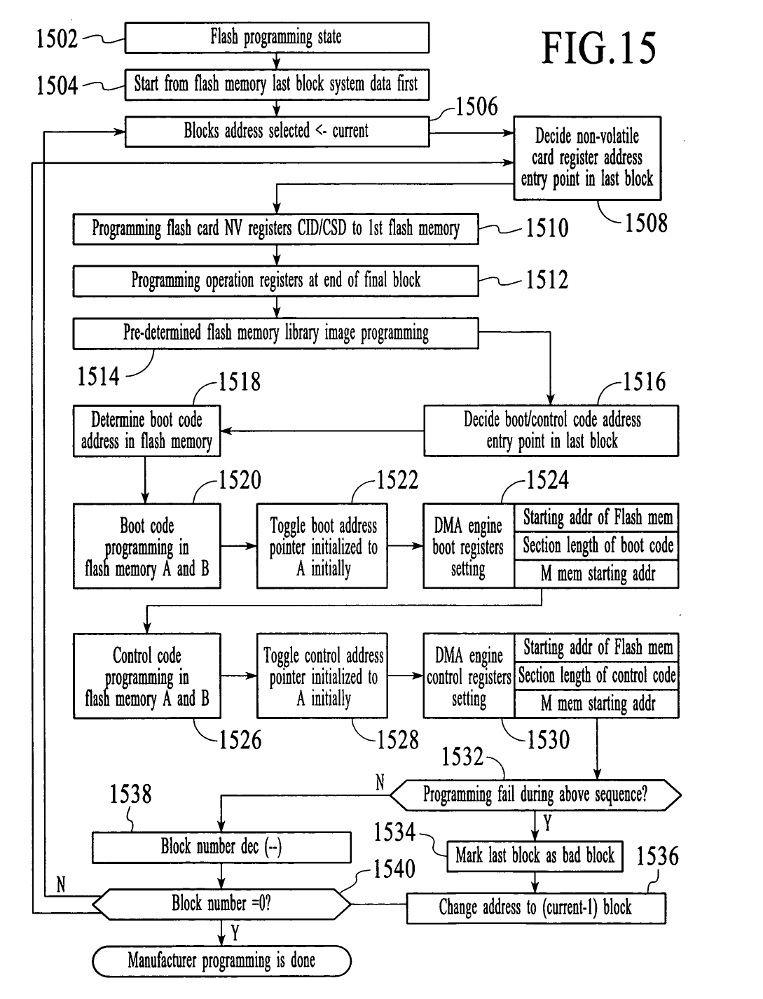

FIG. 15 is a flow chart showing a method for programming a flash card using a flash programmer in accordance with the present invention. In this specific embodiment, the flash programmer is a Jedec flash programmer instead of a manufacturer programmer. A Jedec Flash programmer directly programs flash memory. Each flash device has a unique coding sequence, which is handled by the Jedec flash programmer.

First, an interrupt service routine is executed, in a step 1502. The interrupt service routine is the same as steps 1402-1420 of FIG. 14. Next, the last available block of the flash memory is programmed, in a step 1504. The capacity of the flash memory is known before programming. Next, a block address is selected, in a step 1506. Next, an address is determined for non-volatile (NV) card register address, in a step 1508. Next, NV registers are programmed, in a step 1510. These registers include a card ID (CID) register and a card specific data (CSD) register. The card ID (CID) register includes several sections of ID, manufacturer ID (MID), original equipment manufacturer ID (OEM ID, or OID), product name (PNM), revision (PRV), and serial number, data, CRC7 values for checksum use. The CSD register provides information on how to access the card contents. All of the initial default values are stored in three pages. Read-only data are in one page. The user write-once field is on a different page, such that second programming cannot access this page, an example is card file format or one-time-programming (OTP).

All 127 bits are stored in a one page/sector for easier read access. Every card is programmed as a unique number. Next, an operation condition register (OCR) is programmed, in a step 1512. The OCR contains a card voltage window that the host must know in order to work properly. For example, if the host only supports 3.3V and the card OCR informs the host that the flash card is a 5V device, the card should not operate in the system.

Programming part of the register is achieved by using CMD27, the address of the register which is part of the flash memory physical address is known by firmware, but not accessible to end users.

A relative card address (RCA) register and a driver stage register (DSR) is programmed with default values, which can be later modified. For easier flash programming, a logical one (or “1”) in a flash memory cell is defined as a default value. For example, “1” is busy if the initial card powers up. It is “0” if not busy or the card is finished with the power up sequence.

Next, a predetermined flash memory library image file is programmed, in a step 1514. The library image file stores parameters for the flash memory and is organized, for easy access, as one page. The flash memory interface circuit uses the library image file for command decoding and access timing.

Next, address entry points are determined for boot code and control codes, in a step 1516. Next, the address for the boot code is determined, in a step 1518. Next, the boot code is programmed in the flash memory, in a step 1520. Two copies of the boot code are stored. Next, a boot address pointer is initialized, in a step 1522. Next, the DMA engine and boot registers are set, in a step 1524. The DMA engine is used during a normal code relocation process. Three units are defined to facilitate this feature: the flash physical starting address register; the page length register of transfer; and the main memory address is relocated.

Next, the control code is programmed in the flash memory, in a step 1526. Two copies of the control code are stored. Next, a toggle control address pointer is initialized, in a step 1528. Next, the DMA engine and control registers are set, in a step 1530.

Next, it is determined whether the programming failed, in a step 1532. If programming fails, the last block is marked with a bad block flag (“0”), in a step 1534. The block address is changed to the previous block (last −1), in a step 1536, and the process starts over again. If in step 1514, the programming did not fail, the block number is decremented, in a step 1538. Next, the block number cleared, in a step 1540.

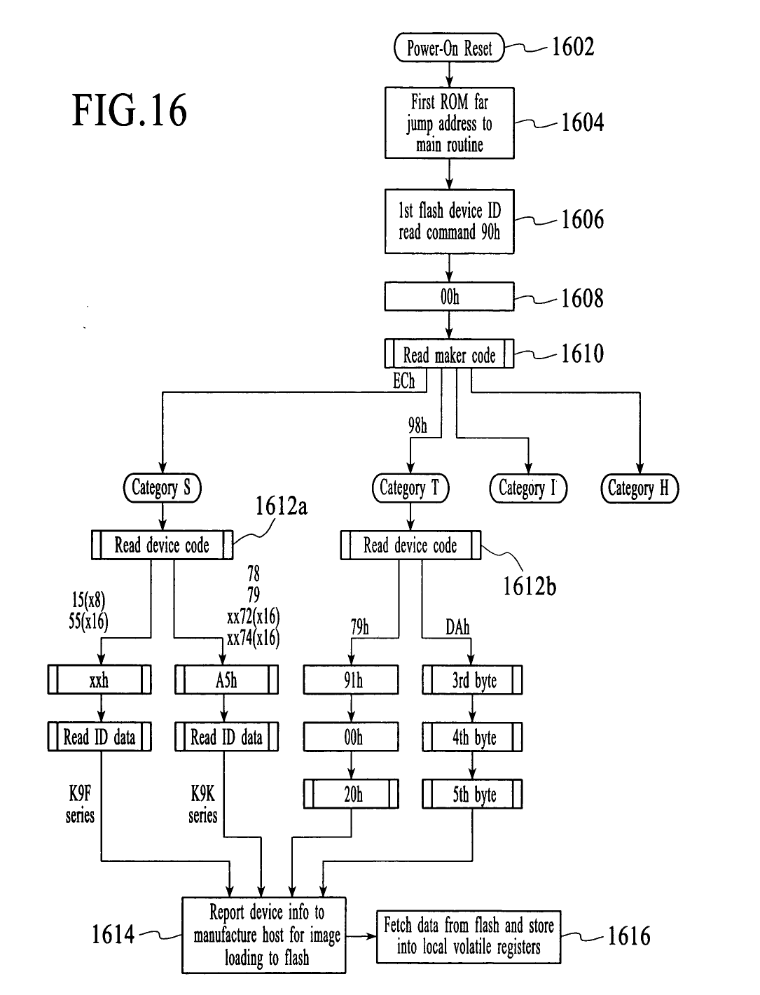

FIG. 16 is a flow chart showing a method for booting a flash card in accordance with the present invention. First, the power-on reset is executed, in a step 1602. This occurs when the flash card is connected to a user host. Next, the reset to card CPU causes an issued resetting address to jump to a main routine of ROM code, in a step 1604. Next, a device ID is read, in a step 1606. This step is initiated by a 90h command. Next, a “00h” address phase is initiated, in a step 1608. Next, a maker code is returned by the flash memory device if the CE# is active, in a step 1610. Various branches of software can be followed, depending on the maker code.

Next, a device code is read, in a step 1612a or 1612b, depending on the maker code (e.g., maker S or maker T). After all of the information is read, it is sent to the manufacturer host, in a step 1614. Next, the manufacturer host writes local volatile registers to the flash memory device, in a step 1616. The manufacturer host also writes the correct library image file to the final blocks of the flash memory.

The ROM sets up operating registers. Once the registers are set, a flash interface circuit can work properly to facilitate the manufacturer host in downloading the library image file to the flash memory device. A short ROM code is desired to facilitate the flash card in recognizing the flash memory device.

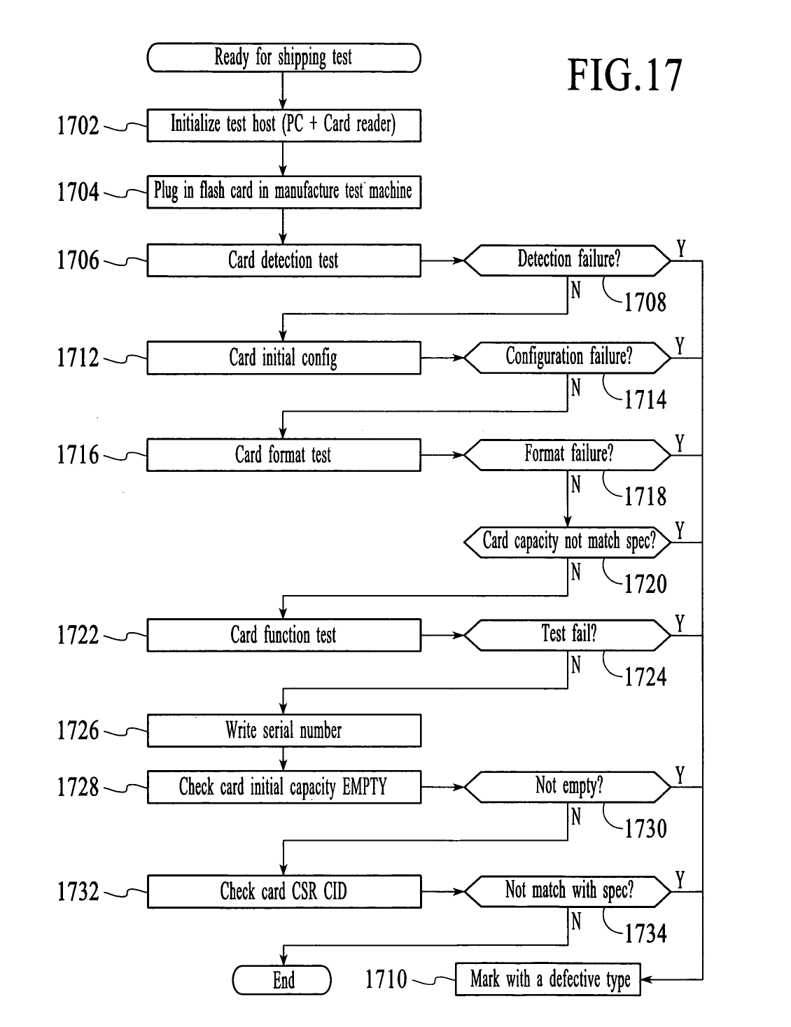

FIG. 17 is a flow chart showing a method for testing a flash card before shipping in accordance with the present invention. First, the manufacturer host is initialized, in a step 1702. The manufacturer host functions as a tester host. The manufacturer host can be a PC with a card reader and a USB or PCMCIA interface. Next, the flash card is connected into the manufacturer host, in a step 1704. For volume production, multiple flash cards can be plugged into the system to increase testing efficiency. Next, a card detection test is executed, in a step 1706. Next, if a failure is detected, in a step 1708, the flash card is marked as defective, in a step 1710. If no failure is detected, the flash card is configured, in a step 1712. The flash card undergoes a low-level format. Next, if a configuration failure is detected, in a step 1714, the flash card is marked as defective, in the step 1710. If no failure is detected, a flash card format test is executed, in a step 1716.

The flash card is formatted to a specified file system. For example, Windows 98 requires a FAT16 system for a total file storage capacity under 128 M bytes, because a 64 K cluster entry covers an entire FAT16 addressing range if the sector size is 512 bytes long. Window 2000 requires a FAT32 system for larger disk capacity. To guarantee a file read capability, FAT16 is assumed for backward compatibility as the default file system. The test program creates a partition table and then executes the formatting. Next, if a format failure is detected, in a step 1718, the flash card is marked as defective, in a step 1710. Next, it is determined if the flash card capacity matches the capacity of the specification, in a step 1720. If the flash card capacity does not match that of the specification, the flash card is marked as defective, in the step 1710. If the flash card capacity matches that of the specification, a card function test is executed, in a step 1722.

Next, if a failure is detected, in a step 1724, the flash card is marked as defective, in the step 1710. If no failure is detected, a serial number is written to the flash card, in a step 1726. Next, the initial flash card capacity is checked, in a step 1728. The flash card capacity needs to be cleared and available before shipping. Accordingly, an erase-whole-card action is performed to reset all user accessible bits to “1”s, except for the necessary tables, registers, etc.

Next, if the flash card is determined not be empty, in a step 1730, the flash card is marked as defective, in the step 1710. If the flash card is empty, the control and status register (CSR), the CID, and the OCR of the flash card is checked, in a step 1732.

Next, if it is determined that the CSR and the CID do not match those of the specification, in a step 1734, the flash card is marked as defective, in the step 1710. If there is a match, the testing sequence is complete.

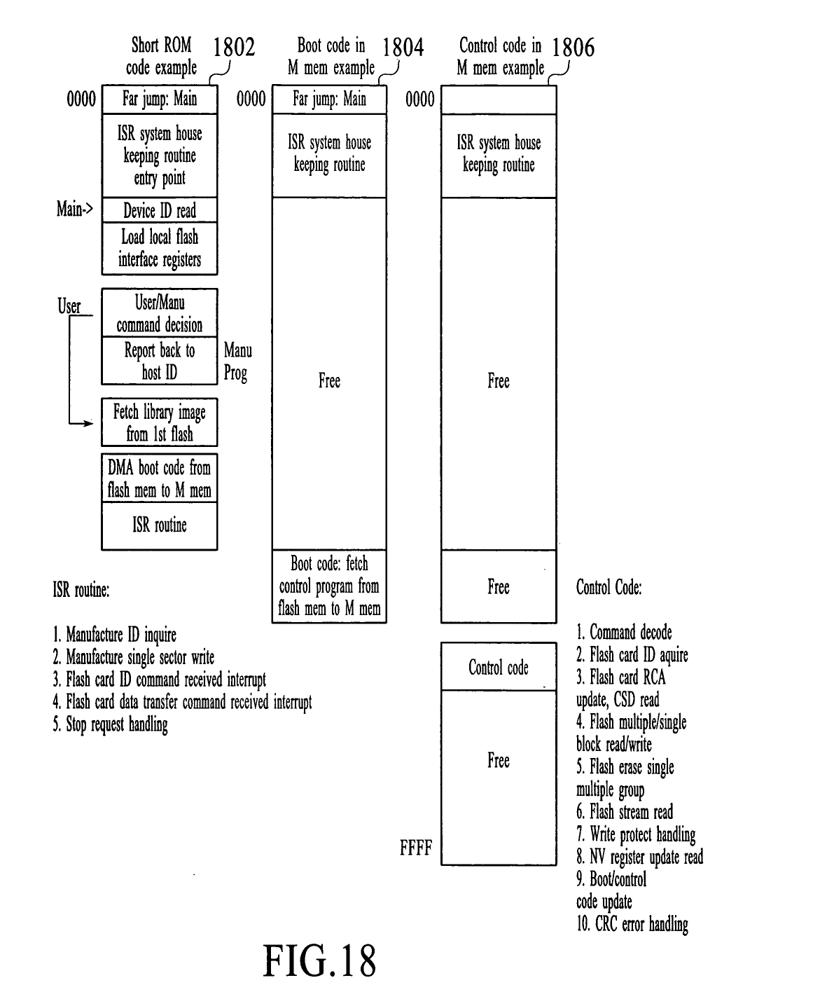

FIG. 18 is a block diagram of memory structures in accordance with the present invention. The software structures include short ROM code 1802, boot code 1804, and control code 1806. One of two modes is selected when the flash card is turned on. One mode is program mode, where flash memory can be programmed as described above. The other mode is normal mode, where the flash card undergoes a normal user power-on sequence.

The type of mode is determined by the command received by the flash card. A manufacturer host would issue a command putting the flash card in programming mode. While in programming mode, the flash image file can be downloaded into the flash card. A user host (e.g., digital camera) would issue a command putting the flash card in normal mode. While in normal mode, the flash card undergoes a normal user power-on sequence.

To minimize the amount of coding in the ROM, a simple sector flash write routine and a basic response back to the manufacturer host are supported in the ROM.

After the manufacturer host knows the type of flash, an image data file is written to the predetermined final block(s) of flash memory before the flash card is shipped to the end user. Alternatively, if the manufacturer already knows the type of flash memory, the image data file can be written to the flash memory without having to determine the type of flash memory.

During normal mode, a power-on reset occurs when the card is first connected to a user host. The flash device ID cycle is issued to fill the local flash interface registers for fetching operations. After a power-on reset, the ROM code 1802 checks the flash card by performing write/reads to all internal volatile registers. A device ID is then read, and parameters are stored in the operation registers of the flash card.

The boot code is needed for DMA download to the main memory (RAM). The DMA download enables fast access to the flash memory device. Because the boot code and control code is stored in the flash memory device, the ROM code can be simple and short. An interrupt service routine (ISR) reserves all entry point addresses. The ISR supports both commands for programming mode and normal mode. At the end of the ROM code, control is passed to the boot code for necessary system operation.

The boot code downloads a more complex control code to the main memory from the reserved blocks of the flash memory device. Control is then passed to the control code. A boot code engine reduces the ROM size and enables the flash card to execute code faster, since the boot code and the control code is fetched from the RAM.

The control code engine handles all flash card protocol commands.

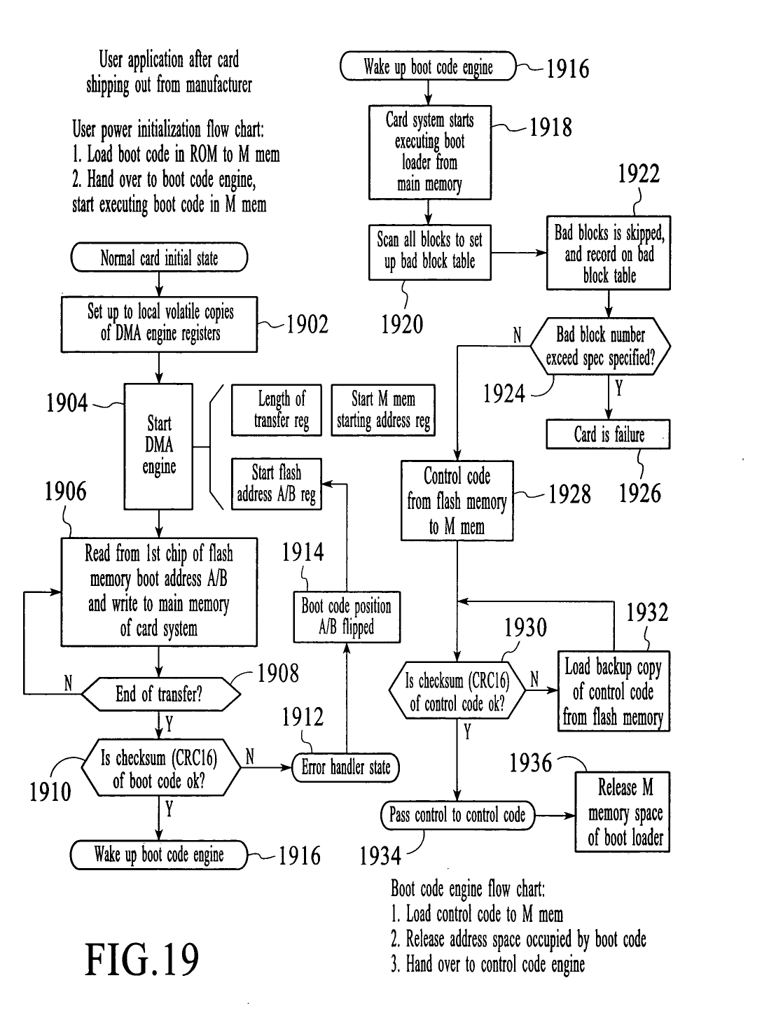

FIG. 19 is a flow chart showing a method for powering up a flash card during normal operation in accordance with the present invention. After being programmed by the manufacture, the flash card can be used by a user normal mode. In the flash cards normal-mode initial state, the flash device type is already known from pre-shipping programming. The flash device type is stored in the flash cards local flash registers.

First, local volatile copies of DMA engine registers are set up, in a step 1902. Next, a direct memory access (DMA) engine is initialized, in a step 1904. As a part of the DMA engine initialization, local registers are programmed. Next, the boot code is read from the flash memory device and is written to the main memory, in a step 1906. The DMA engine transfers the boot code to the main memory. As a part of the boot code read, the boot code's starting physical sector address and its sector length are read. Next, it is determined whether the transfer is complete, in a step 1908. If not, the transfer step 1906 is repeated. If the transfer is complete, the checksum (CRC16) of the boot code is checked to ensure it is correct, in a step 1910. If not, the flash card enters an error handler state, in a step 1912. Next, a flip pointer is toggled to fetch the backup copy of the boot code in the flash memory, in a step 1914. Next, DMA process is repeated starting at the step 1904. Any errors are recorded by incrementing a counter that keeps count of the number of failures. If at step 1910, the checksum is determined to be correct, the boot code engine activated, in a step 1916.

Next, the boot code is executed from the main memory, in a step 1918. Next, all blocks are scanned for bad blocks, and a bad block map is established, in a step 1920. Upon completion of the scanning, the user data capacity is known to the flash memory system and is stored in a non-volatile register. The bad block map is located in the final block of the flash memory device, and in the first flash memory device if more than one device is used. Next, bad blocks are skipped and recorded in the bad block map, in a step 1922. Next, it is determined whether the number bad blocks exceeds a predetermined tolerance, in a step 1924. If yes, the flash card is designated as a failure and a warning is issued, in a step 1926. If not, the control code is read from the flash memory device and is written to the main memory, in a step 1928. Next, the checksum (CRC16) of the control code is checked if correct, in a step 1930. If not, the backup copy of the control code transferred to the main memory, in a step 1932, and the checksum is checked, in the step 1930. If the checksum is correct, control is passed from the boot code engine to the control code engine, in a step 1934. Next, after the flash memory system has booted up, and after the loading of the control code into the main memory, the memory space occupied by the boot code is freed up for other purposes, in a step 1936. As such, execution of the control code becomes more efficient.

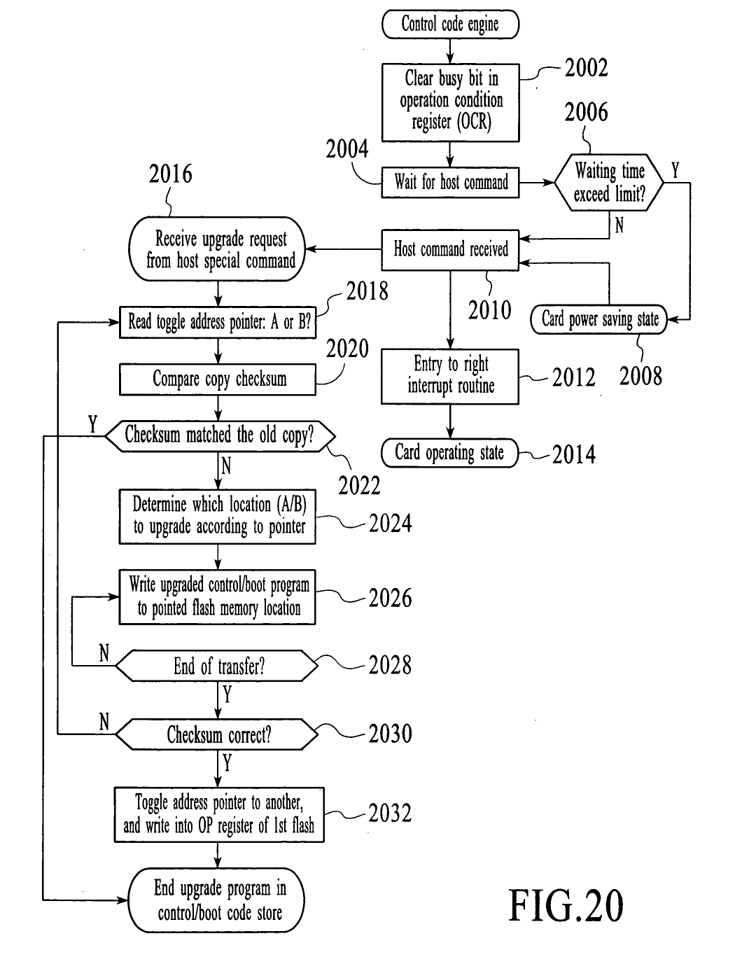

FIG. 20 is a flow chart showing a method for implementing control code during normal operation in accordance with the present invention. Once control code engine is initiated, a busy bit in the operation control register (OCR) is cleared, in a step 2002. Next, the control code is ready to accept further host commands and waits, in a step 2004. Next, it is determined whether the waiting time has exceeded a predetermined time limit, in a step 2006. If yes, a power saving state is initiated, in a step 2008, before receiving a new host command, in a step 2010. If the waiting time has not exceeded the predetermined time limit, the control code continues to wait until the predetermined limit is exceeded or a host command is received, in the step 2010.

Any command received, triggers an appropriate interrupt service routine, in a step 2012. Next, the command is decoded so that the control code can perform the specified task (e.g., data transferring, ID recognizing, etc.), in a step 2014. Another feature of the present invention is that a user can update the boot code or control code during field operation. This feature is valuable whenever a bug occurs or is discovered in the boot code or the control code after the flash card is shipped. As stated previously, a second copy of the boot code and the control code is stored in the flash memory in case an error occurs during the update.

In the step 2010, the host command can include a special update command, in a step 2016. The updated boot code or control code can be downloaded using a PC from various sources such as the Internet. In a specific embodiment, the updated code contains the special update command. A flip pointer points to the location of updated code copy, in a step 2018. After a successful update, the flip pointer is toggled for next revision.

Next, the checksum of the updated copy is compared to that of the old copy, in a step 2020. Next, it is determined whether the checksums match, in a step 2022. If they match, the update process is complete. If they don't match, the flip pointer is used to determine which copy to update, in a step 2024. Next, the appropriate copy is updated, in a step 2026. Next, it is determined whether the update is complete, in a step 2028. If not, the step 2026 is repeated. If the transfer is completed, the checksums checked to ensure it is the correct checksum, in a step 2030. If not, the update process repeats from the step 2018. If the checksum is correct, the address pointer is toggled, in a step 2032, before the update process is complete.

The control code can be big, since it handles the update process. However, because the control code is stored in flash memory instead of in the fixed ROM, it provides much flexibility and value to support in the field.

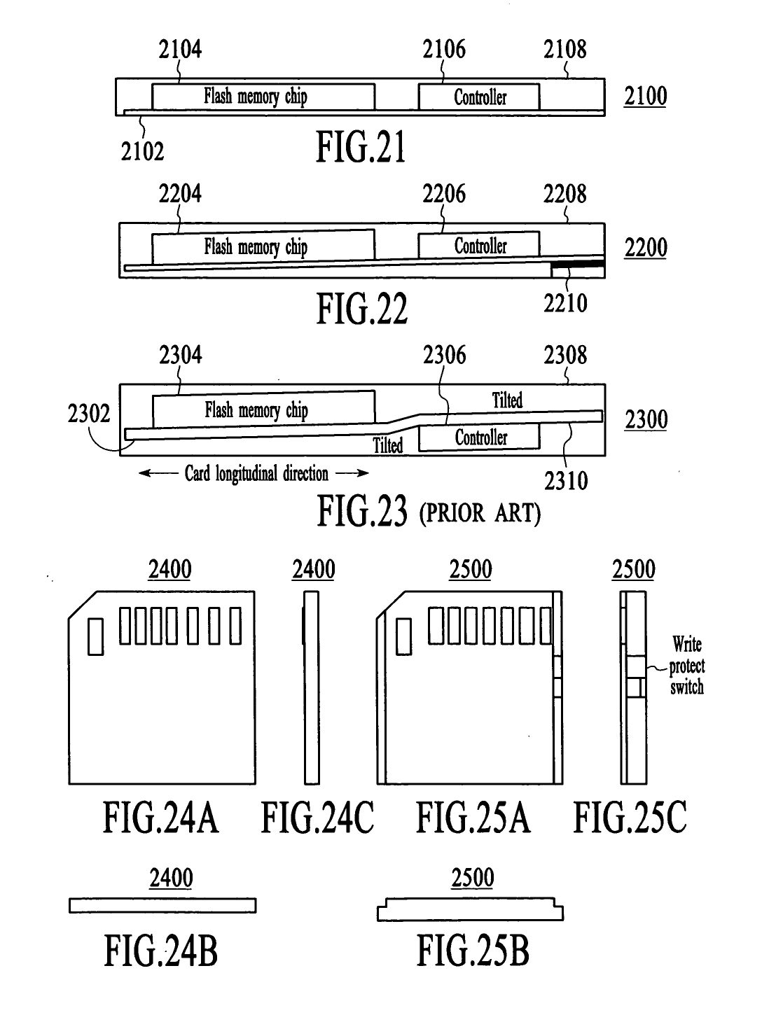

FIG. 21 is a side-view diagram of a conventional multimedia card (MMC) 2100. The MMC 2100 includes a printed circuit board (PCB) 2102, a flash memory device 2104, a flash controller 2106, and a cover or housing 2108. Conventional flash cards have many form factors. MMCs have strict height limitations, about 1.4 mm. This forces the flash memory device 2104 and the flash controller 2106 to use a very-very-small-outline-package (WSOP), about 0.7 mm in height. This height restriction increases the cost of card production, because it is difficult to handle thin package ICs. Also, handling the die alone (i.e., without a package) is even more difficult during board production.

FIG. 22 is a side-view diagram of an MMC 2200 in accordance with the present invention. The MMC 2200 includes a printed circuit board (PCB) 2202, a flash memory device 2204, a flash controller 2206, a cover 2208, and metal contact pads 2210. To overcome the difficulty of the conventional MMC, a thin-small-outline-package (TSOP), 1.1 mm in height, for the flash memory device can be used with the present invention. The flash controller can still use a WSOP package. As a result, the height position of the PCB can be increased on one end of the MMC 2200. For example, the height could be increased such that the cover height has about 2.1 mm thickness form factor (+−0.3 mm). Allowing the extra height can relieve the low-yield production problem, and can make it easier to insert the MMC into a host receptacle. As shown, the PCB 2202 is tilted at one end of the MMC 2200.

The flash memory device 2204 and the flash controller 2206 are located on the same side of the PCB 2202. The metal contact pads 2210 located near the leading edge of PCB 2202 on the opposite side of the PCB 2202. The PCB 2202 is positioned with a small inclined angle as it is tilted up slightly in the leading edge. The tilting results in more available space above PCB toward its trailing edge. As a result, the requirement to meet the minimum wall thickness and flexibility in the selection of flash memory chips (e.g., TSOP with a thickness of 0.1 mm) can be fulfilled and relaxed. On the other end, the metal contact pads 2210 are slightly tilted, in the same orientation of PCB 2202. The metal contact pads are received in a receptacle inside a user host (not shown) via a flexible spring (not shown). The tilted orientation enables a firm electrical contact from between the flash card and the host.

FIG. 23 is a side-view diagram of a conventional MMC. The MMC 2300 includes a printed circuit board (PCB) 2302, a flash memory device 2304, a flash controller 2306, a cover 2308, and metal contact pads 2310. A clearance of 0.7 mm under the metal contact pads 2310 is maintained in the card with a total thickness of at least 2.1 mm. This leaves the space above PCB 2302 to be about 1.1 mm. Using a PCB 2302 with a thickness of about 0.3 mm accommodates all of the IC's and the upper portion of the cover. The minimum thickness requirement for the cover is about 0.3 mm, based on standard industrial practice. This leaves about 0.8 mm for the IC's mounted above the PCB.

The disadvantage with the conventional MMC of FIG. 23 is that the PCB 2302 must be bent in two places order to accommodate the flash memory device 2304 and the flash controller 2306. As shown, the PCB 2302 is bent between the flash memory device 2304 and the flash controller 2306. The PCB is also be bent between the flash controller 2306 and the metal contact pads 2310. Such bends introduce undesired complexity and increased manufacturing costs. In contrast, the MMC of FIG. 22 uses the PCB 2204, which is simpler and easier to make than the PCB 2302 of FIG. 23.

FIGS. 24a, 24b, and 24c are top-view, back-view, and side-view diagrams, respectively, of a conventional MMC 2400. The MMC 2400 has a form factor with a thickness of 1.4 mm.

FIGS. 25A, 25B, and 25C are top-view, back-view, and side-view diagrams, respectively, of a multimedia card (MMC) 2500 in accordance with the present invention. The MMC 2600 has a cover with a form factor of 2.1 mm, like that of the secure digital (SD) card form factor. Under most circumstances, a user host with an SD mechanical socket can receive both MMC and SD card protocols, because the location of the MMC metal contact pad coincides with that of the SD standard.

Because none of the write-protect hardware has been defined in the MMC specification, the data stored in a card having an MMC form factor are subject to accidental removal. This can result in data loss in personal and/or business applications. The embodiment described herein enables MMC functionality in a SD form factor, while leveraging the write-protect feature that is available in SD products. The electrical-mechanical contact inside a host device (not shown) is established, and the write-protect is activated when the card is inserted and the write-protect switch in the card is set in a proper position.

SD card protocol support extra commands such as ACMD41, which the MMC protocol does not. During the power-on card ID recognizing process, a user host knows this difference by probing with an extra command and branches to different identification states without confusion.

The present invention can be applied to any controller-embedded Flash card including but not limited to MultiMediaCard (MMC), Secure Disk (SD), Memory Stick (MS), Compact Flash (CF), as well as USB controller-based flash memory devices.

According to the system and method disclosed herein, the present invention provides numerous benefits. For example, it enables the boot and control codes to be updated in the field without having to change the flash controller. Also, it enables the flash controller to support various brands and types of flash memory devices. Also, because the boot and control codes are stored in the flash memory instead of the ROM, the code in the ROM is minimized. As a result, the ROM can be made smaller.

A system in accordance with the present invention for providing a flash memory system has been disclosed. The flash memory system stores boot code and the control code in the flash memory instead of in the ROM. As a result, the boot and control codes can be updated in the field without having to change the flash controller.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be stored in some form of computer-readable medium, such as memory or CD-ROM, or is to be transmitted over a network, and executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A flash memory card system comprising:
a flash controller; and
at least one flash memory device coupled to the flash controller, wherein boot code and control code are stored in the flash memory device.

2. The system of claim 1 wherein the flash memory stores two copies of the boot code.

3. The system of claim 2 wherein during an update, one of the two copies of the boot code is updated and the other of the two copies remains a backup copy.

4. The system of claim 1 wherein the flash memory stores two copies of the control code.

5. The system of claim 4 wherein during an update, one of the two copies of the control code is updated and other of the two copies remains a backup copy.

6. The system of claim 1 wherein the flash controller comprises a main memory.

7. The system of claim 6 wherein the boot code and the control code are transferred from the flash memory device to the main memory when the flash memory system is booted.

8. The system of claim 7 wherein direct memory access (DMA) is used to transfer the boot code and the control code from the flash memory to the main memory.

9. The system of claim 7 wherein the boot code is transferred to the main memory before the control code is transferred to the main memory, and wherein the flash memory system frees up memory space in the main memory occupied by the boot code after the control code is transferred to the main memory.

10. The system of claim 1 wherein the flash controller can support multiple brands and multiple types of flash memory.

11. The system of claim 1 wherein the flash controller can interleave multiple flash memory devices.

12. The system of claim 1 wherein the flash controller can perform multiple channel operations.

13. The system of claim 12 wherein the multiple channel operations comprise dual channel operations.

14. The system of claim 1 wherein the circuit can be applied to flash cards comprising MultiMediaCard (MMC), Secure Disk (SD), Memory Stick (MS), Compact Flash (CF), and USB controller-based flash memory devices.

15. The system of claim 1 further comprising:
a printed circuit board (PCB) coupled to the flash controller and the at least one flash memory device; and
a cover, wherein the PCB is tilted relative to the cover.

16. The system of claim 15 wherein the cover has a height of substantially 2.1 mm.

17. The system of claim 15 wherein the at least one flash memory device is mounted to one side of the PCB and the flash controller is mounted to the same side of the PCB.

18. The system of claim 17 wherein the positions of the at least one flash memory device and the flash controller are offset longitudinally such that an unpopulated space exists between the flash memory device and the flash controller.

19. The system of claim 15 wherein the system can be received in a secure digital (SD) card socket.

20. A flash memory system comprising:
a host;
a flash controller; and
at least one flash memory device coupled to the flash controller, wherein boot code and control code are stored in the flash memory device, wherein the host downloads the boot code and the control code into the flash memory device.

21. The system of claim 20 wherein the host downloads the boot code and the control code into the flash memory device via the flash controller.

22. The system of claim 20 wherein the host downloads the boot code and the control code into the flash memory device directly.

23. The system of claim 20 wherein the host is a Jedec flash programmer.

24. The system of claim 20 wherein the host is a user host.

25. The system of claim 20 wherein the flash memory stores two copies of the boot code.

26. The system of claim 25 wherein during an update, one of the two copies of the boot code is updated and the other of the two copies remains a backup copy.

27. The system of claim 20 wherein the flash memory stores two copies of the control code.

28. The system of claim 27 wherein during an update, one of the two copies of the control code is updated and other of the two copies remains a backup copy.

29. The system of claim 20 wherein the flash controller comprises a main memory.

30. The system of claim 29 wherein the boot code and the control code are transferred from the flash memory device to the main memory when the flash memory system is booted.

31. The system of claim 30 wherein direct memory access (DMA) is used to transfer the boot code and the control code from the flash memory to the main memory.

32. The system of claim 30 wherein the boot code is transferred to the main memory before the control code is transferred to the main memory, and wherein the flash memory system frees up memory space in the main memory occupied by the boot code after the control code is transferred to the main memory.

33. The system of claim 20 wherein the flash controller can support multiple brands and multiple types of flash memory.

34. The system of claim 20 wherein the flash controller can interleave multiple flash memory devices.

35. The system of claim 20 wherein the flash controller can perform multiple channel operations.

36. The system of claim 35 wherein the multiple channel operations comprise dual channel operations.

37. The system of claim 20 wherein the circuit can be applied to flash cards comprising MultiMediaCard (MMC), Secure Disk (SD), Memory Stick (MS), Compact Flash (CF), and USB controller-based flash memory devices.

38. The system of claim 20 further comprising:
a printed circuit board (PCB) coupled to the flash controller and the at least one flash memory device; and
a cover, wherein the PCB is tilted relative to the cover.

39. The system of claim 38 wherein the cover has a height of substantially 2.1 mm.

40. The system of claim 38 wherein the at least one flash memory device is mounted to one side of the PCB and the flash controller is mounted to the same side of the PCB.

41. The system of claim 40 wherein the positions of the at least one flash memory device and the flash controller are offset longitudinally such that an unpopulated space exists between the flash memory device and the flash controller.

42. The system of claim 38 wherein the system can be received in a secure digital (SD) card socket.

43. A method for implementing a flash memory system, the method comprising:
providing a flash memory device; and
storing boot code and control code in the flash memory device.

44. The method of claim 43 wherein the storing step comprises downloading the boot code and the control code into the flash memory device utilizing a host.

45. The method of claim 44 wherein the host is a Jedec flash programmer.

46. The method of claim 43 wherein the storing step comprises downloading at least two copies of the boot code.

47. The method of claim 43 wherein the storing step comprises downloading at least two copies of the control code.

48. The method of claim 43 further comprising testing the flash memory system before shipping.

49. The method of claim 48 wherein the testing comprises determining if attributes of the flash memory system match those of the specification

50. The method of claim 43 further comprising updating the boot code in the flash memory.

51. The method of claim 43 further comprising updating the control code in the flash memory.

52. The method of claim 43 further comprising transferring the boot code and the control code from the flash memory device to a main memory when the flash memory system is booted.

53. The method of claim 52 further comprising transferring the boot code and the control code from the flash memory device to the main memory utilizing a direct memory access (DMA).

54. The method of claim 52 wherein the boot code is transferred to the main memory before the control code is transferred to the main memory.

55. The method of claim 54 further comprising freeing up memory space in the main memory occupied by the boot code after the control code is transferred to the main memory.

56. The method of claim 43 wherein the method can be applied to flash cards comprising MultiMediaCard (MMC), Secure Disk (SD), Memory Stick (MS), Compact Flash (CF), and USB controller-based flash memory devices.

57. A computer readable medium containing program instructions for implementing a flash memory system, the program instructions which when executed by a computer system cause the computer system to execute a method comprising:
providing a flash memory device; and
storing boot code and control code in the flash memory device.

58. The computer readable medium of claim 57 wherein the storing step comprises program instructions for downloading the boot code and the control code into the flash memory device utilizing a host.

59. The computer readable medium of claim 58 wherein the host is a Jedec flash programmer.

60. The computer readable medium of claim 57 wherein the storing step comprises program instructions for downloading at least two copies of the boot code.

61. The computer readable medium of claim 57 wherein the storing step comprises program instructions for downloading at least two copies of the control code.

62. The computer readable medium of claim 57 further comprising program instructions for testing the flash memory system before shipping.

63. The computer readable medium of claim 62 wherein the testing step further comprises program instructions for determining if attributes of the flash memory system match those of the specification

64. The computer readable medium of claim 57 further comprising program instructions for updating the boot code in the flash memory.

65. The computer readable medium of claim 57 further comprising program instructions for updating the control code in the flash memory.

66. The computer readable medium of claim 57 further comprising program instructions for transferring the boot code and the control code from the flash memory device to a main memory when the flash memory system is booted.

67. The computer readable medium of claim 66 further comprising program instructions for transferring the boot code and the control code from the flash memory device to the main memory utilizing a direct memory access (DMA).

68. The computer readable medium of claim 66 wherein the boot code is transferred to the main memory before the control code is transferred to the main memory.

69. The computer readable medium of claim 68 further comprising program instructions for freeing up memory space in the main memory occupied by the boot code after the control code is transferred to the main memory.

70. The computer readable medium of claim 57 wherein the computer readable medium can be applied to flash cards comprising MultiMediaCard (MMC), Secure Disk (SD), Memory Stick (MS), Compact Flash (CF), and USB controller-based flash memory devices.
